(19) United States
(12) Patent Application Publication
(10) Pub. No.: US 2020/0044693 A1
(43) Pub. Date: Feb. 6, 2020

(54) BLUETOOTH RECEIVING APPARATUS, BLUETOOTH POSITIONING SYSTEM AND BLUETOOTH POSITIONING METHOD

(71) Applicant: BOE TECHNOLOGY GROUP CO., LTD., Beijing (CN)

(72) Inventors: Hongyan PEI, Beijing (CN); Lingfeng XU, Beijing (CN); Wei DENG, Beijing (CN)

(21) Appl. No.: 16/404,172

(22) Filed: May 6, 2019

(30) Foreign Application Priority Data
Aug. 1, 2018 (CN) 201810862407.3

(51) Int. Cl. H04B 3/54; H04W 64/00; H04W 4/80; H04B 17/318; G01S 11/06

(52) U.S. Cl. CPC H04B 3/544; H04W 64/003; G01S 11/06; H04B 3/542; H04B 17/318; H04W 4/80

(57) ABSTRACT

The present application provides a Bluetooth receiving apparatus, a Bluetooth positioning system and a Bluetooth positioning method. The Bluetooth receiving apparatus includes: a Bluetooth receiver configured to receive a positioning signal from a Bluetooth terminal and determine a signal strength value of the received positioning signal; and a power carrier modulator configured to modulate the received signal strength value onto a power carrier signal to transmit the modulated power carrier signal through a power line.

### CROSS-REFERENCE TO RELATED APPLICATION(S)

This application claims priority to the Chinese Patent Application No. 201810862407.3, filed on Aug. 1, 2018, which is incorporated herein by reference in its entirety.

### TECHNICAL FIELD

The present disclosure relates to the field of wireless positioning, and more particularly, to a Bluetooth receiving apparatus, a Bluetooth positioning system, and a Bluetooth positioning method.

### BACKGROUND

Currently, positioning systems such as Beidou systems, Global Positioning System (GPS) systems etc. may achieve good positioning effects in open outdoor areas. However, it is often difficult to apply these systems in indoor areas. In the related art, most of indoor positioning solutions are implemented based on Bluetooth communication, that is, a plurality of positioning modules capable of directly performing Bluetooth communication with an intelligent terminal are disposed indoors, and the intelligent terminal accesses the Internet through WIFI to obtain positioning information and map information from a server. Such indoor positioning solutions mainly have the following problems. Firstly, signal transmission using wireless communication techniques such as WIFI etc. may be blocked and shielded by walls, floors or other metal shielding structures, which affects the positioning effects; and secondly, after power stored by a positioning module is used up, it needs to replace the positioning module with a new positioning module, which results in a large maintenance workload and a high cost.

### SUMMARY

The present disclosure provides a Bluetooth receiving apparatus, a Bluetooth positioning system, and a Bluetooth positioning method.

According to an aspect of the present disclosure, there is provided a Bluetooth receiving apparatus. The Bluetooth receiving apparatus comprises: a Bluetooth receiver configured to receive a positioning signal from a Bluetooth terminal and determine a received signal strength value of the received positioning signal; and a power carrier modulator configured to modulate the received signal strength value onto a power carrier signal to transmit the modulated power carrier signal through a power line.

In some embodiments, the power carrier modulator is further configured to modulate position information of the Bluetooth receiving apparatus onto the power carrier signal of the power line and transmit the power carrier signal through the power line.

In some embodiments, the positioning signal further comprises at least one of Identity (ID) information of the Bluetooth terminal and positioning time information with respect to transmission of the positioning signal, and the power carrier modulator is further configured to modulate the at least one of the ID information of the Bluetooth terminal and the positioning time information with respect to transmission of the positioning signal onto the power carrier signal together with the received signal strength value.

In some embodiments, the Bluetooth receiving apparatus further comprises: a first power converter configured to perform rectification and voltage regulation on alternating current from the power line to provide power to the Bluetooth receiving apparatus.

In some embodiments, the Bluetooth receiving apparatus is integrated on or carried in an indoor device.

According to an aspect of the present disclosure, there is provided a Bluetooth positioning system for positioning a Bluetooth terminal. The Bluetooth positioning system comprises: a plurality of Bluetooth receiving apparatuses according to the above embodiments; a gateway electrically connected to the plurality of Bluetooth receiving apparatuses through power lines, and configured to obtain received signal strength values from the plurality of Bluetooth receiving apparatuses through the respective power lines; and a positioning server communicatively connected to the gateway, and configured to obtain, from the gateway, the received signal strength values from the plurality of Bluetooth receiving apparatuses, and determine a position of the Bluetooth terminal based on the received signal strength values.

In some embodiments, the gateway comprises: a power carrier demodulator configured to demodulate the received signal strength values from respective power carrier signals; and an Ethernet interface configured to transmit the received signal strength values to the positioning server.

In some embodiments, the power carrier demodulator is further configured to demodulate position information of the Bluetooth receiving apparatuses, and the Ethernet interface is further configured to transmit the demodulated position information of the Bluetooth receiving apparatuses to the positioning server.

In some embodiments, the power carrier demodulator is further configured to demodulate at least one of Identity (ID) information of the Bluetooth terminal and positioning time information with respect to transmission of the positioning signal together with the received signal strength values, and the Ethernet interface is further configured to transmit the demodulated at least one of the ID information of the Bluetooth terminal and the positioning time information with respect to transmission of the positioning signal to the positioning server together with the received signal strength values.

In some embodiments, the gateway further comprises: a second power converter configured to provide power to the gateway.

According to an aspect of the present disclosure, there is provided a positioning method using the Bluetooth positioning system according to any of the embodiments described above. The method comprises: receiving, by the plurality of Bluetooth receiving apparatuses, positioning signals from the Bluetooth terminal respectively, and determining received signal strength values of the received positioning signals; modulating, by the plurality of Bluetooth receiving apparatuses, the received signal strength values onto power carrier signals respectively, to transmit the modulated power carrier signals through power lines; receiving, by the gateway, the modulated power carrier signals through the respective power lines, and demodulating the received signal strength values from the plurality of Bluetooth receiving apparatuses according to the modulated power carrier signals; and receiving, by the positioning server from the gateway, the received signal strength values from the plurality of Bluetooth receiving apparatuses, and determining a position of the Bluetooth terminal based on the received signal strength values.

In some embodiments, the method further comprises: modulating, by the plurality of Bluetooth receiving apparatuses, the position information of the respective Bluetooth receiving apparatuses onto the respective power carrier signals, and transmitting the power carrier signals through the respective power lines; and determining, by the positioning server, the position of the Bluetooth terminal based on the position information of the Bluetooth receiving apparatuses and the respective received signal strength values.

In some embodiments, the method further comprises: determining, by each of the Bluetooth receiving apparatuses, at least one of Identity (ID) information of the Bluetooth terminal and positioning time information for transmission of a corresponding positioning signal according to the positioning signal; and determining, by the positioning server, the position of the Bluetooth terminal based on the at least one of the ID information of the Bluetooth terminal and the positioning time information with respect to transmission of the positioning signal and a corresponding received signal strength value for each of the Bluetooth receiving apparatuses.

In some embodiments, determining the position of the Bluetooth terminal based on the received signal strength values comprises: determining the position of the Bluetooth terminal using a three-point positioning method.

### BRIEF DESCRIPTION OF THE ACCOMPANYING DRAWINGS

The specific embodiments of the present disclosure will be further described in detail below with reference to the accompanying drawings.

FIG. 1 is a schematic diagram of a Bluetooth positioning system according to an embodiment of the present disclosure;

FIG. 2 is a schematic diagram of a communication link of a Bluetooth positioning system according to an embodiment of the present disclosure; and

FIG. 3 is a flowchart of a method for performing indoor positioning by combining Bluetooth with power carriers according to an embodiment of the present disclosure.

### DETAILED DESCRIPTION

In order to explain the present disclosure more clearly, the present disclosure will be further described below in conjunction with the embodiments and the accompanying drawings. Similar components in the accompanying drawings are denoted by the same reference signs. It should be understood by those skilled in the art that the following detailed description is illustrative instead of being restrictive, and is not intended to limit the protection scope of the present disclosure.

Power line carrier communication technology is a new generation of narrowband high-speed power line carrier communication. Power line carrier communication may provide connections and communication without blind spots and blind angles to terminal devices through power lines, thereby ensuring stable communication of terminal devices installed at any positions. In addition, the power line carrier communication has the greatest advantage that there is no need to additionally set up a data transmission medium, and therefore is more compatible with existing building structures and easier to implement.

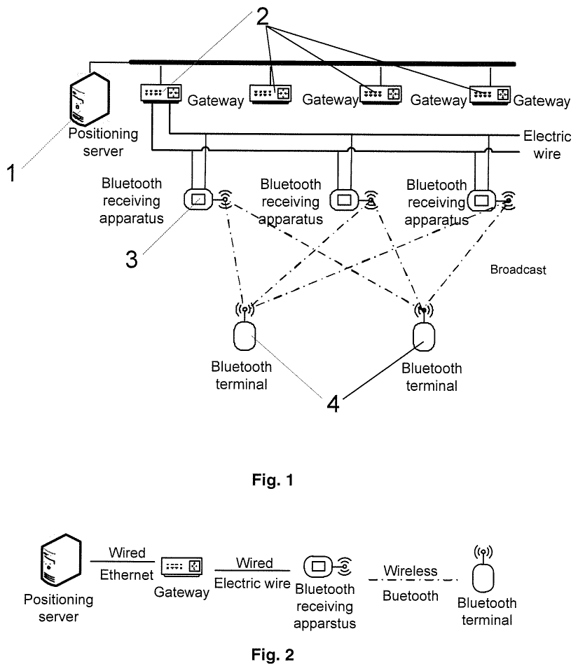

As shown in FIG. 1, the present disclosure provides a Bluetooth positioning system for positioning a Bluetooth terminal. In the following description, an indoor scene is taken as an example, but it should be understood that the present disclosure is not limited thereto.

The Bluetooth positioning system comprises a positioning server 1, gateways 2, and Bluetooth receiving apparatuses 3. Also shown in FIG. 1 are Bluetooth terminals 4 as objects to be positioned. Each of the Bluetooth terminals 4 comprises a Bluetooth module, and each of the Bluetooth terminals 4 is configured with corresponding ID information which is unique. The Bluetooth module is configured to be in a Beacon mode to periodically transmit a broadcast signal to the outside to report its own ID information.

The Bluetooth receiving apparatus 3 comprises: a Bluetooth receiver configured to receive a positioning signal from a Bluetooth terminal and determine a received signal strength value of the received positioning signal; and a power carrier modulator configured to modulate the received signal strength value onto a power carrier signal to transmit the modulated power carrier signal through a power line.

In some embodiment, the power carrier modulator is further configured to modulate position information of the Bluetooth receiving apparatus 3 onto the power carrier signal of the power line and transmit the power carrier signal through the power line.

In some embodiment, the positioning signal further comprises at least one of ID information of the Bluetooth terminal 4 and positioning time information with respect to transmission of the positioning signal. The power carrier modulator is further configured to modulate the at least one of the ID information of the Bluetooth terminal 4 and the positioning time information with respect to transmission of the positioning signal onto the power carrier signal together with the received signal strength value.

In some embodiment, the Bluetooth receiving apparatus 3 further comprises: a first power converter configured to perform rectification and voltage regulation on alternating current from the power line to provide power to the Bluetooth receiving apparatus 3.

In some embodiment, the Bluetooth receiving apparatus 3 may be integrated on or carried in an indoor device.

The gateway 2 is electrically connected to the plurality of Bluetooth receiving apparatuses 3 through power lines, and is configured to obtain received signal strength values from the plurality of Bluetooth receiving apparatuses 3 through the respective power lines.

In some embodiments, the gateway 2 comprises: a power carrier demodulator configured to demodulate the received signal strength values from respective power carrier signals; and an Ethernet interface configured to transmit the received signal strength values to the positioning server 1.

In some embodiments, the power carrier demodulator is further configured to demodulate position information of the Bluetooth receiving apparatuses 3, and the Ethernet interface is further configured to transmit the demodulated position information of the Bluetooth receiving apparatuses 3 to the positioning server 1.

In some embodiments, the power carrier demodulator is further configured to demodulate at least one of ID information of the Bluetooth terminal 4 and positioning time information with respect to transmission of the positioning signal together with the received signal strength values, and the Ethernet interface is further configured to transmit the demodulated at least one of the ID information of the Bluetooth terminal 4 and the positioning time information with respect to transmission of the positioning signal to the positioning server 1 together with the received signal strength values.

In some embodiments, the gateway 2 further comprises: a second power converter configured to provide power to the gateway 2.

The positioning server 1 is communicatively connected to the gateway 2, and is configured to obtain, from the gateway 2, the received signal strength values from the plurality of Bluetooth receiving apparatuses 3, and determine a position of the Bluetooth terminal 4 based on the received signal strength values.

An operation of the Bluetooth positioning system in FIG. 1 will be described below by way of an exemplary embodiment. The Bluetooth receiving apparatuses 3 may be installed in various household devices (for example, televisions, air conditioners, refrigerators, routers etc.) which are infrequently moved, or may also be fixed at certain positions at home. A first power converter of each Bluetooth receiving apparatus 3 is connected to an electric wire, to perform rectification and voltage regulation on household 220V alternating current to provide power to the Bluetooth receiving apparatus 3, without an additional power supply source. A Bluetooth receiver of each Bluetooth receiving apparatus 3 is wirelessly connected to the Bluetooth terminal 4, receives a wireless positioning broadcast signal (for example, a wireless broadcast signal) transmitted by the Bluetooth terminal 4 as an object to be positioned, acquires information (for example, ID information of the Bluetooth terminal 4) included in the positioning signal, and determines a Received Signal Strength (RSSI) value of the positioning signal. The Bluetooth receiver transmits the ID information and the received signal strength value to a power carrier modulator. Since there are a plurality of Bluetooth receiving apparatuses 3 installed indoors, after the Bluetooth terminal 4 transmits a broadcast signal with ID information, Bluetooth receivers in the plurality of Bluetooth receiving apparatuses 3 receive the signal respectively, and since distances between the plurality of Bluetooth receiving apparatuses 3 and the Bluetooth terminal 4 are different, the plurality of Bluetooth receiving apparatuses 3 receive signals with different received signal strength.

A Bluetooth receiver of each Bluetooth receiving apparatus 3 transmits received ID information and a received signal strength value of the Bluetooth terminal 4 to a corresponding power carrier modulator, and the power carrier modulator modulates the received ID information and the received signal intensity value onto a power carrier signal, and then transmits the power carrier signal to the gateway 2 through an electric wire. The electric wire here generally refers to an indoor electric wire having working current passing therethrough. As a result, there is no need to additionally set up a communication line, thereby saving a cost of lines and an indoor space.

In the present exemplary embodiment, the gateway 2 comprises a power carrier demodulator, a second power converter, a processor, and an Ethernet interface, wherein the second power converter is connected to an electric wire, to perform rectification and voltage regulation on household 220V alternating current to provide power to the gateway 2. The power carrier demodulator is configured to demodulate a lot of ID information and respective received signal strength values in the electric wire from respective power carrier signals, and then transmit the signals to the processor. The received ID information and the respective received signal strength values are processed and packaged in the processor, and the packaged signals are uploaded to the positioning server 1 through the Ethernet interface.

The positioning server 1 receives the ID information and the received signal strength values of the Bluetooth terminal 4 acquired by the respective Bluetooth receiving apparatuses 3, and calculates a position of the Bluetooth terminal 4 using a positioning algorithm such as a three-point positioning method or a multi-point positioning method.

Each of the Bluetooth receiving apparatuses 3 may further provide its own position information. The position information of the respective Bluetooth receiving apparatuses 3 may be stored in the positioning server and updated periodically.

As shown in FIG. 2, the Bluetooth terminal 4 wirelessly communicates with the Bluetooth receiving apparatuses 3, and other communication processes are realized in a wired manner. Here, each of the Bluetooth receiving apparatuses 3 communicates with the gateway 2 using a power line. With the power line carrier communication technology, there is no need to additionally set up communication lines, thereby saving an overhead of lines and a cost for rebuilding lines. The Bluetooth receiving apparatuses 3 may be embedded in related power devices, such as fluorescent lamps, televisions, stereos, surveillance cameras, etc. The gateway 2 communicates with the positioning server 1 through the Ethernet.

In the present embodiment, with the apparatus for performing indoor positioning by combining Bluetooth and power carriers, the wireless Bluetooth positioning information is transmitted to the positioning server in a form of power carriers, to calculate a coordinate position for positioning, which, as compared with conventional Bluetooth positioning apparatuses, not only realizes stable transmission signals and accurate positioning, but also may achieve arrangement of the Bluetooth receiving apparatuses in the entire setup process of the apparatuses without changing related power and communication lines and without additionally setting up data transmission lines and wireless communication networks. The Bluetooth receiving apparatuses are directly powered by the power lines without installing batteries and replacing batteries, thereby saving costs and facilitating later maintenance.

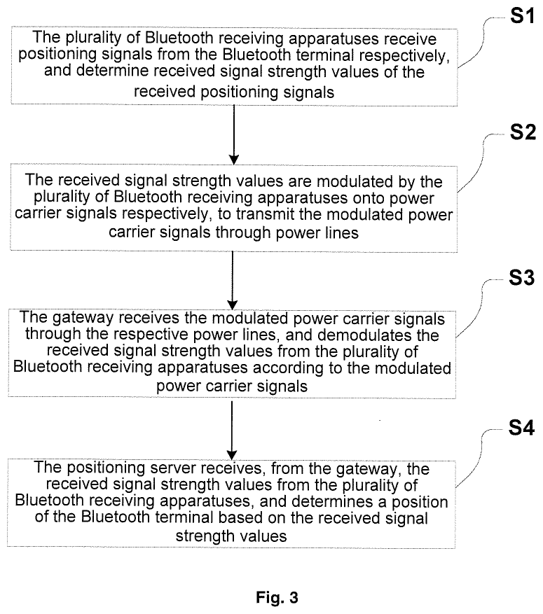

As shown in FIG. 3, illustrated is a Bluetooth positioning method according to an embodiment of the present disclosure. The Bluetooth positioning method may be implemented by the Bluetooth positioning system shown in FIG. 1. Therefore, the explanation and description of the Bluetooth positioning system shown in FIG. 1 above are equally applicable here. The Bluetooth positioning method comprises the following steps.

In S1, the plurality of Bluetooth receiving apparatuses (for example, the Bluetooth receiving apparatuses 3) receive positioning signals from the Bluetooth terminal (for example, the Bluetooth terminal 4) respectively, and determine received signal strength values of the received positioning signals.

In S2, the received signal strength values are modulated by the plurality of Bluetooth receiving apparatuses (for example, the Bluetooth receiving apparatuses 3) onto power carrier signals respectively, to transmit the modulated power carrier signals through power lines.

In S3, the gateway (for example, the gateway 2) receives the modulated power carrier signals through the respective power lines, and demodulates the received signal strength values from the plurality of Bluetooth receiving apparatuses (for example, the Bluetooth receiving apparatuses 3) according to the modulated power carrier signals.

In S4, the positioning server (for example, the positioning server 1) receives, from the gateway (for example, the gateway 2), the received signal strength values from the plurality of Bluetooth receiving apparatuses (for example, the Bluetooth receiving apparatuses 3), and determines a position of the Bluetooth terminal (for example, the Bluetooth terminal 4) based on the received signal strength values.

In some embodiments, the method further comprises: modulating, by the plurality of Bluetooth receiving apparatuses (for example, the Bluetooth receiving apparatuses 3), the position information of the respective Bluetooth receiving apparatuses (for example, the Bluetooth receiving apparatuses 3) onto the respective power carrier signals, and transmitting the power carrier signals through the respective power lines; and determining, by the positioning server (for example, the positioning server 1), the position of the Bluetooth terminal (for example, the Bluetooth terminal 4) based on the position information of the Bluetooth receiving apparatuses (for example, the Bluetooth receiving apparatuses 3) and the respective received signal strength values.

In some embodiments, the method further comprises: determining, by each of the Bluetooth receiving apparatuses (for example, the Bluetooth receiving apparatuses 3), at least one of Identity (ID) information of the Bluetooth terminal (for example, the Bluetooth terminal 4) and positioning time information for transmission of a corresponding positioning signal according to the positioning signal; and determining, by the positioning server (for example, the positioning server 1), the position of the Bluetooth terminal (for example, the Bluetooth terminal 4) based on the at least one of the ID information of the Bluetooth terminal (for example, the Bluetooth terminal 4) and the positioning time information with respect to transmission of the positioning signal and a corresponding received signal strength value for each of the Bluetooth receiving apparatuses (for example, the Bluetooth receiving apparatuses 3).

The technical solutions according to the present disclosure provide connections and communication without blind spots and blind angles to terminal devices through power carriers, which solves the problem in the related art that signal transmission is blocked or shielded by walls, floors or other metal structures, thereby ensuring reliable connection, stable communication and accurate positioning of terminal devices installed at any positions. The technical solutions are applicable to application scenarios in which indoor positioning is required, such as office buildings, schools, hospitals etc., and arrangement of the Bluetooth receiving apparatuses may be achieved in an installation process without changing related power and communication lines and without additionally setting up data transmission lines and wireless communication networks. The Bluetooth receiving apparatuses are directly powered by the power lines without installing batteries and replacing batteries, thereby saving costs and facilitating later maintenance.

It is apparent that the above-described embodiments of the present disclosure are merely examples for the purposes of clearly illustrating the present disclosure, and are not intended to limit the embodiments of the present disclosure. Those of ordinary skill in the art may further make other different forms of variations or changes on the basis of the above description. Not all the embodiments may be described here, and various obvious variations or changes which are obtained from the technical solutions of the present disclosure still fall within the protection scope of the present disclosure.

I/We claim:

1. A Bluetooth receiving apparatus, comprising:
a Bluetooth receiver configured to receive a positioning signal from a Bluetooth terminal and determine a received signal strength value of the received positioning signal; and
a power carrier modulator configured to modulate the received signal strength value onto a power carrier signal to transmit the modulated power carrier signal through a power line.

2. The Bluetooth receiving apparatus according to claim 1, wherein the power carrier modulator is further configured to modulate position information of the Bluetooth receiving apparatus onto the power carrier signal of the power line and transmit the power carrier signal through the power line.

3. The Bluetooth receiving apparatus according to claim 1, wherein the positioning signal further comprises at least one of Identity (ID) information of the Bluetooth terminal and positioning time information with respect to transmission of the positioning signal, and the power carrier modulator is further configured to modulate the at least one of the ID information of the Bluetooth terminal and the positioning time information with respect to transmission of the positioning signal onto the power carrier signal together with the received signal strength value.

4. The Bluetooth receiving apparatus according to claim 1, further comprising:
a first power converter configured to perform rectification and voltage regulation on alternating current from the power line so as to provide power to the Bluetooth receiving apparatus.

5. The Bluetooth receiving apparatus according to claim 1, wherein the Bluetooth receiving apparatus is integrated on or carried in an indoor device.

6. A Bluetooth positioning system for positioning a Bluetooth terminal, comprising:
a plurality of Bluetooth receiving apparatuses according to claim 1;
a gateway electrically connected to the plurality of Bluetooth receiving apparatuses through power lines, and configured to obtain received signal strength values from the plurality of Bluetooth receiving apparatuses through the respective power lines; and
a positioning server communicatively connected to the gateway, and configured to obtain, from the gateway, the received signal strength values from the plurality of Bluetooth receiving apparatuses, and determine a position of the Bluetooth terminal based on the received signal strength values.

7. The Bluetooth positioning system according to claim 6, wherein the gateway comprises:
a power carrier demodulator configured to demodulate the received signal strength values from respective power carrier signals; and
an Ethernet interface configured to transmit the received signal strength values to the positioning server.

8. The Bluetooth positioning system according to claim 7, wherein the power carrier demodulator is further configured to demodulate position information of the Bluetooth receiving apparatuses, and the Ethernet interface is further configured to transmit the demodulated position information of the Bluetooth receiving apparatuses to the positioning server.

9. The Bluetooth positioning system according to claim 7, wherein the power carrier demodulator is further configured to demodulate at least one of Identity (ID) information of the Bluetooth terminal and positioning time information with respect to transmission of the positioning signal together with the received signal strength values, and the Ethernet interface is further configured to transmit the demodulated at least one of the ID information of the Bluetooth terminal and the positioning time information with respect to transmission of the positioning signal to the positioning server together with the received signal strength values.

10. The Bluetooth positioning system according to claim 6, wherein the gateway further comprises: a second power converter configured to provide power to the gateway.

11. A positioning method using a Bluetooth positioning system comprising:
a plurality of Bluetooth receiving apparatuses including a Bluetooth receiver configured to receive a positioning signal from a Bluetooth terminal and determine a received signal strength value of the received positioning signal, and a power carrier modulator configured to modulate the received signal strength value onto a power carrier signal to transmit the modulated power carrier signal through a power line;
a gateway electrically connected to the plurality of Bluetooth receiving apparatuses through power lines, and configured to obtain received signal strength values from the plurality of Bluetooth receiving apparatuses through the respective power lines; and
a positioning server communicatively connected to the gateway, and configured to obtain, from the gateway, the received signal strength values from the plurality of Bluetooth receiving apparatuses, and determine a position of the Bluetooth terminal based on the received signal strength values,
the method comprising:
receiving, by the plurality of Bluetooth receiving apparatuses, positioning signals from the Bluetooth terminal respectively, and determining received signal strength values of the received positioning signals;
modulating, by the plurality of Bluetooth receiving apparatuses, the received signal strength values onto power carrier signals respectively, to transmit the modulated power carrier signals through power lines;
receiving, by the gateway, the modulated power carrier signals through the respective power lines, and demodulating the received signal strength values from the plurality of Bluetooth receiving apparatuses according to the modulated power carrier signals; and
receiving, by the positioning server from the gateway, the received signal strength values from the plurality of Bluetooth receiving apparatuses, and determining a position of the Bluetooth terminal based on the received signal strength values.

12. The method according to claim 11, further comprising:
modulating, by the plurality of Bluetooth receiving apparatuses, the position information of the respective Bluetooth receiving apparatuses onto the respective power carrier signals, and transmitting the power carrier signals through the respective power lines; and
determining, by the positioning server, the position of the Bluetooth terminal based on the position information of the Bluetooth receiving apparatuses and the respective received signal strength values.

13. The method according to claim 11, further comprising:
determining, by each of the Bluetooth receiving apparatuses, at least one of Identity (ID) information of the Bluetooth terminal and positioning time information for transmission of a corresponding positioning signal according to the positioning signal; and
determining, by the positioning server, the position of the Bluetooth terminal based on the at least one of the ID information of the Bluetooth terminal and the positioning time information with respect to transmission of the positioning signal and a corresponding received signal strength value for each of the Bluetooth receiving apparatuses.

14. The method according to claim 12, further comprising:
determining, by each of the Bluetooth receiving apparatuses, at least one of Identity (ID) information of the Bluetooth terminal and positioning time information for transmission of a corresponding positioning signal according to the positioning signal; and
determining, by the positioning server, the position of the Bluetooth terminal based on the at least one of the ID information of the Bluetooth terminal and the positioning time information with respect to transmission of the positioning signal and a corresponding received signal strength value for each of the Bluetooth receiving apparatuses.

15. The method according to claim 11, wherein determining the position of the Bluetooth terminal based on the received signal strength values comprises:
determining the position of the Bluetooth terminal using a three-point positioning method.
